(19) United States
(12) Patent Application Publication
(10) Pub. No.: US 2024/0282148 A1
(43) Pub. Date: Aug. 22, 2024

(54) METHOD AND SYSTEM FOR ELECTRONIC SIGNATURE VERIFICATION

(71) Applicant: SecureSign, Inc., Warminster, PA (US)

(72) Inventors: Gene Brodsky, Warminster, PA (US); Siarhei Stsiapanau, Warminster, PA (US); Kirill Grigorchuck, Warminster, PA (US); Edward Kanevsky, Warminster, PA (US); Victor Melnikov, Warminster, PA (US); Bogdana Brodsky, Warminster, PA (US)

(73) Assignee: SecureSign, Inc., Warminster, PA (US)

(21) Appl. No.: 18/571,431

(22) PCT Filed: Aug. 19, 2022
(86) PCT No.: PCT/US2022/040915

§ 371 Date: Dec. 18, 2023

Related U.S. Application Data
(60) Provisional application No. 63/234,947, filed on Aug. 19, 2021.

(51) Int. Cl. G06V 40/30; G06V 20/00

(52) U.S. Cl. CPC G06V 40/30; G06V 20/95

(57) ABSTRACT

A system and method for authenticating an electronic signature uses a unique tone or color embedded within a video, image. or sound recording taken during execution of an electronic document. The person signing the electronic document would not be able to replicate the tone or color, as it is randomly assigned and changes for each document that will be signed.

### CROSS-REFERENCE TO RELATED APPLICATIONS

This application claims the benefit under 35 U.S.C. § 119 of U.S. Provisional Application Ser. No. 63/234,947, filed on Aug. 19, 2021, which is incorporated herein by reference.

### STATEMENT REGARDING FEDERALLY SPONSORED RESEARCH

Not applicable.

### BACKGROUND OF THE INVENTION

The invention relates generally to signature verification. More specifically, the invention relates to a system and method of authenticating an electronic signature to ensure that the identity of the person signing the document matches the identity associated with the signature on the document.

Electronic documents are now common and the preferred document format for many people and businesses. However, some documents must be signed on physical copies because of an inability to authenticate electronic signatures, which could be electronically applied by a person other than the indicated signer. Some prior art systems have used video as a means of authenticating the signature. However, the video could be manipulated by the user, particularly if the video does not show the actual signature being created. Therefore, it would be advantageous to develop a system and method that can authenticate electronic signatures.

### BRIEF SUMMARY

According to one embodiment of the present invention is a system and method of authenticating electronic signatures, where a unique audio tone, color signal, or both are produced during the signature event. A video or still image recorded when the signature is made captures the tone or color signal and uses it to authenticate the signature. The color signal can be captured through a reflection and does not have to be directly viewed by the image capture device.

### BRIEF DESCRIPTION OF THE SEVERAL VIEWS OF THE DRAWINGS

FIGS. 1A-1B are flowcharts of the process of authenticating an electronic signature.

### DETAILED DESCRIPTION

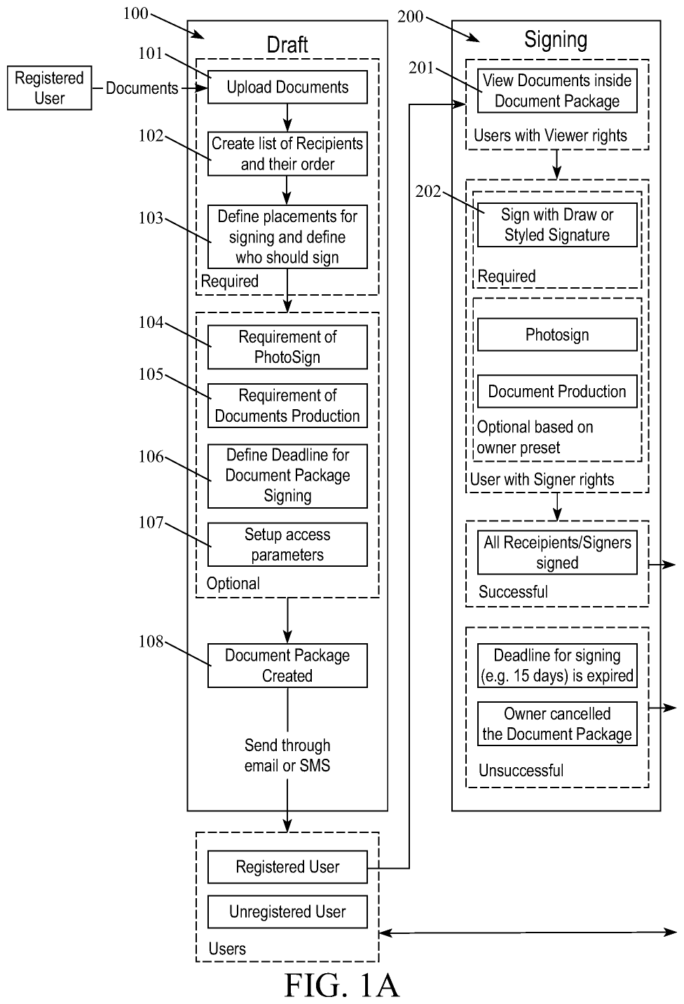

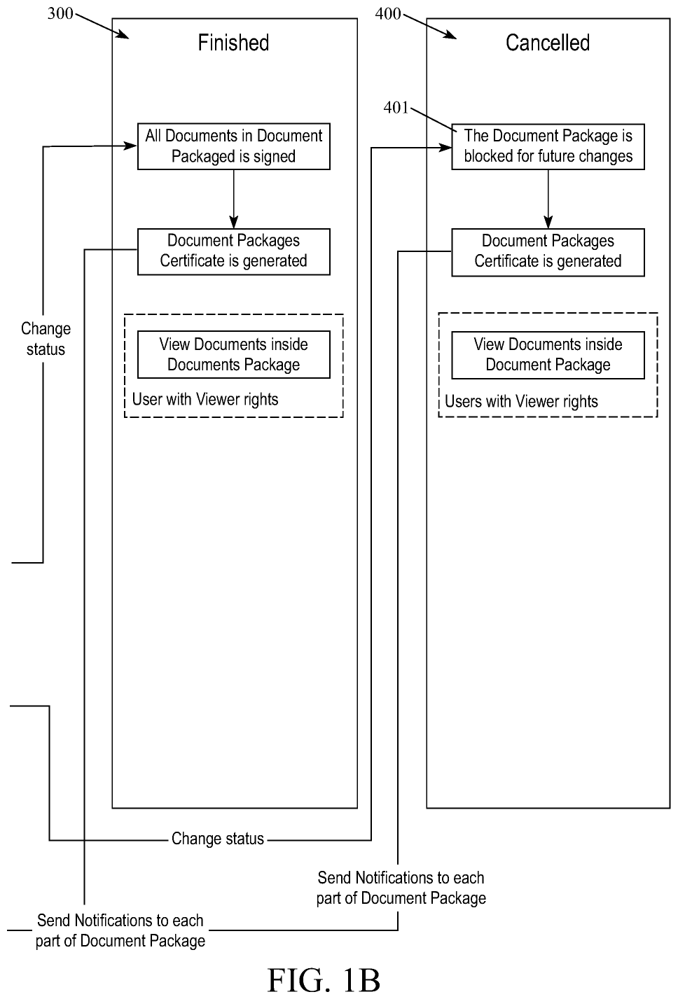

In one example embodiment, as shown in FIGS. 1A-1B, the method of authenticating a signature comprises four core steps. At step 100, a document is drafted, followed by signing at step 200, finishing at step 300, and an optional cancelation at step 400. During document creation at step 100, a user is presented with several required and optional sub-steps. The user can be the person requesting a signature and creating the electronic document. The required steps include uploading documents (step 101), creating a list of recipients (102), and defining the signature placements (103). Other inputs, such as name, email, dates, initial, and similar details can be entered during this step (103). The documents can be uploaded in various formats, such as PDF, Word, Excel, JPEG, and similar digital file formats. Recipients can be identified by name, email address, or other unique identifiers such as a credentials for accessing a cloud-based account.

The document drafting step 100 may include several optional steps, including adding signature verification requirements (step 104), document production requirements (105), deadlines (106), and assigning access parameters (107). At step 104, signature verification may include several processes to ensure that the person signing the electronic document is the person designated as the signer. For example, one verification process may include recording a video or image of the person signing the electronic document. In many instances, the signer is signing a document using a phone, tablet, computer, or other electronic device having an image capture device such as a camera. Using the camera, an image or video of the signer's face can be captured during the signing event. For example, at random and/or designated points of the document signature process (such as at the time of signature or initial opening of the document) the system will capture images and will keep them in the certificate of completion as proof that the same person who initiated the document review is the same person present reviewing and signing the document. This functionality can be used independently of other signature verification processes at step 104 and, at a user's request, can be used in connection with other verification processes. For example, a user can request the signer to upload identification documents (such as a passport, driver's license, etc.) for comparison to the captured image. In one embodiment, facial recognition technology can be used to compare the photo/video of the signer with the uploaded image to verify the identity of signee. A user will be able to select security levels and parameters required for each signature or set their default requirements and modify each signature request as needed.

While the image capture and facial recognition processes provide a level of authentication, it does not actually capture a video or image of the signature being placed on the electronic document. Stated differently, there is no direct evidence associating the identified signer with the act of signing the document. To overcome this problem, the process of the current disclosure may add two additional authentication processes by providing a unique audio tone or color signal to the signing process. These additional authentication processes can be used individually or together. A unique sequence (i.e. combination of alphanumeric and special characters) is randomly generated and assigned to each document. The unique sequence can be used to generate the unique audio tone or color sequence. The tone or sequence is captured during the signing event and can be translated back to the unique sequence to authenticate the document. This process will also prevent deep fake images and video files. The unique sequence can be saved in the certificate.

By way of further example, an audio tone is a sound played from the speakers of the electronic device used by the signee to execute the document. The audio tone, when based on the unique sequence, is a random tone that could not be replicated by the signer. By capturing this tone on video or through a sound recording, the signature can be verified by matching the captured tone with the tone assigned to the electronic document. To prevent fraud in situations where the tone is played but the signer fails to execute the document, a second, unique tone will be played for subsequent attempts to sign the document. Additionally, the signer can be asked to recite a passphrase generated from the unique sequence associated with the document.

In a similar manner to the audio tone, a unique color signal can be displayed in the background of an electronic document on the screen of the electronic device. The color will reflect off a signer's face and clothing and will be captured by the camera of the electronic device. Alternatively, the unique color tone can be captured directly. The specific color captured can be authenticated by matching the color signal with a color signal assigned to the electronic document based on the unique sequence. In some situations, a user may require both an audio tone and color signal authentication.

After a registered user sets the parameters for verification at step 104 and the other optional parameters, a document package is created at step 108. At this stage of the process, a notification can be sent to the signee that a document package is awaiting signature.

Signing occurs at step 200, with the verification processes indicated at step 104 initiated. At step 201, a signer can view the documents within the document package. Next the signee will sign the document (step 202). Depending on the parameters set by the user, the signing process can include verification steps, including video capture, audio tone, and color signal authentication techniques. The status of the document is changed to ‘successful’ if all required signers execute the document. Alternatively, the document can be changed to ‘unsuccessful’ status if signatures are not captured within a set deadline or the user cancels the document package.

Finalizing the document package occurs at step 300. During this process, a document package certificate is generated at step 301. A user with viewer rights has the ability to view the document package and certificate during this stage of the process. If the signing at step 200 is unsuccessful, the document may be blocked for future changes at step 401. If the user cancels the document, then the document is also locked and a document package certificate is generated indicated the ‘canceled’ or ‘unsuccessful’ status.

While the disclosure has been described in detail and with reference to specific embodiments thereof, it will be apparent to one skilled in the art that various changes and modification can be made therein without departing from the spirit and scope of the embodiments. Thus, it is intended that the present disclosure cover the modifications and variations of this disclosure provided they come within the scope of the appended claims and their equivalents.

Further, the features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. In particular, one or more features in any of the embodiments described herein may be combined with one or more features from any other embodiments described herein.

Protection may also be sought for any features disclosed in any one or more published documents referred to and/or incorporated by reference in combination with the present disclosure.

What is claimed is:

1. A method of authenticating an electronic signature comprising:
sending an electronic document to a user;
instructing the user to electronically sign the document;
displaying on an electronic device having a screen the document to the user with a unique color tone;
capturing an image of the user signing the document on the electronic device, wherein the unique color tone is captured in the image; and
matching the captured color tone to the unique color tone associated with the document.

2. The method of claim 1, wherein the unique color tone is randomly generated from a unique sequence associated with the document.

3. The method of claim 1, further comprising:
authenticating the signature based on the captured color tone.

4. The method of claim 1, further comprising:
comparing the captured image of the user to a known image of the user.

5. The method of claim 1, wherein the unique color tone is captured indirectly through a reflection on the user.

6. The method of claim 1, wherein the unique color tone is displayed in a background of the electronic document.

7. The method of claim 1, further comprising:
displaying the document to the user with a unique audio tone;
capturing a sound recording when the user signs the document, wherein the unique audio tone is captured in the sound recording; and
matching the captured audio tone to the unique audio tone associated with the document.

8. The method of claim 7, wherein the user is authenticated using at least one of the captured color tone and the captured audio tone.

9. A method of authenticating an electronic signature comprising:
sending an electronic document to a user;
instructing the user to electronically sign the document;
displaying the document to the user with a unique audio tone;
capturing a video of the user signing the document, wherein the unique audio tone is captured in the video; and
matching the captured audio tone to the unique audio tone associated with the document.

10. The method of claim 9, wherein the unique audio tone is randomly generated from a unique sequence associated with the document.

11. The method of claim 4, further comprising:
comparing the captured video of the user to a known image of the user.
